(19) United States
(12) Patent Application Publication
(10) Pub. No.: US 2021/0002499 A1
(43) Pub. Date: Jan. 7, 2021

(54) Radiation Curing Ink Jet Printing Method

(71) Applicant: Seiko Epson Corporation, Tokyo (JP)

(72) Inventors: Chigusa SATO, Shiojiri (JP); Toru SAITO, Yamagata (JP); Keitaro NAKANO, Matsumoto (JP)

(21) Appl. No.: 16/919,148

(22) Filed: Jul. 2, 2020

(30) Foreign Application Priority Data
Jul. 4, 2019 (JP) 2019-125070

(51) Int. Cl. C09D 11/101; C09D 11/322; C09D 11/107; B41J 11/00; B41M 5/00

(52) U.S. Cl. CPC C09D 11/101; C09D 11/322; B41M 5/0023; B41J 11/002; C09D 11/107

(57) ABSTRACT

A radiation curing ink jet printing method for forming a cured coating having a thickness of 0.5 μm to 5 μm includes an ejection step of ejecting a radiation-curable ink composition onto a printing medium, and an irradiation step of irradiating the radiation-curable ink composition on the printing medium with an active radiation having an emission peak wavelength in the range of 350 nm to 420 nm from an active radiation source. The radiation-curable ink composition contains one or more monofunctional monomers and one or more multifunctional monomers in such a proportion that the ratio of the total mass of the monofunctional monomers to the total mass of the multifunctional monomers is 0.45 or more. In the irradiation step, the radiation-curable ink composition is irradiated with the active radiation in an atmosphere having an oxygen concentration lower than the atmospheric oxygen concentration.

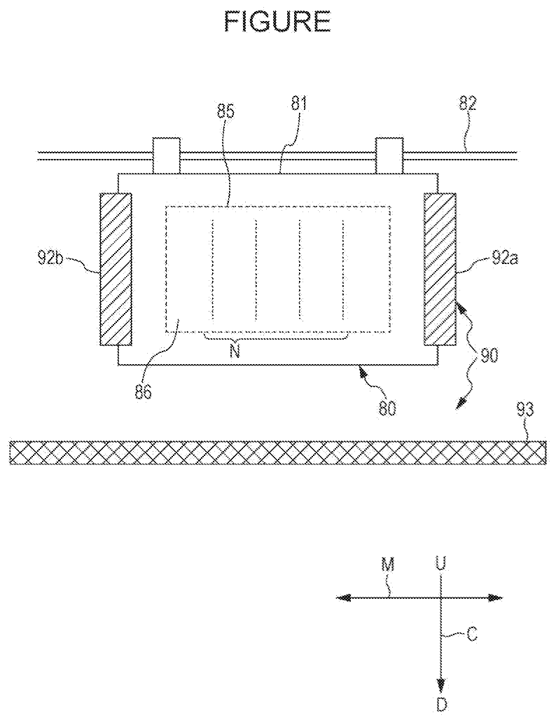

The present application is based on, and claims priority from JP Application Serial Number 2019-125070, filed Jul. 4, 2019, the disclosure of which is hereby incorporated by reference herein in its entirety.

### BACKGROUND

### 1. Technical Field

The present disclosure relates to a radiation curing ink jet printing method.

### 2. Related Art

An ink jet printing method has been used for forming an image, a pattern, or the like on a printing medium with a radiation-curable ink capable of being cured by irradiation with radiation. Radiation-curable inks cure slowly before being irradiated with radiation but cure rapidly when irradiated, thus having a beneficial feature as printing inks. In addition, radiation-curable inks do not contain solvents, which are not involved in the reaction of the ink. Accordingly, such radiation-curable inks are unlikely to release volatile solvents even when cured, thus, being environmentally friendly.

In an ink jet printing method using a radiation-curable ink (disclosed in, for example, JP-A-2015-80921), a cured coating can be formed on a food packaging film by curing the ink by active energy irradiation in an atmosphere having an oxygen concentration lower than the atmospheric oxygen concentration.

Beneficially, such a cured coating is flexible and sufficiently cured, and shrinkage thereof by curing does not cause the printing medium to wrinkle.

### SUMMARY

1. The present disclosure provides a radiation curing ink jet printing method for forming a cured coating having a thickness of 0.5 μm to 5 μm. The method includes an ejection step of ejecting a radiation-curable ink composition onto a printing medium, and an irradiation step of irradiating the radiation-curable ink composition on the printing medium with an active radiation having an emission peak wavelength in a range of 350 nm to 420 nm from an active radiation source in an atmosphere having an oxygen concentration lower than the atmospheric oxygen concentration. The radiation-curable ink composition contains at least one monofunctional monomer and at least one multifunctional monomer in such a proportion that the ratio of the total mass of the at least one monofunctional monomer to the total mass of the at least one multifunctional monomer is 0.45 or more.

2. In the radiation curing ink jet printing method of 1, the radiation-curable ink composition may further contain a photopolymerization initiator in a proportion of 0.20 or more relative to the total mass of all the monomers.

3. In the radiation curing ink jet printing method of 1 or 2, the radiation-curable ink composition may further contain a white pigment.

4. In the radiation curing ink jet printing method of any one of 1 to 3, the average solubility parameter on a mass basis of the at least one monofunctional monomer and the at least one multifunctional monomer may be 7 to 10.

5. In the radiation curing ink jet printing method of any one of 1 to 4, the at least one monofunctional monomer may include a monofunctional cyclic acrylate.

6. In the radiation curing ink jet printing method of any one of 1 to 5, the at least one monofunctional monomer may include a monofunctional heterocyclic acrylate.

7. In the radiation curing ink jet printing method of any one of 1 to 6, the at least one monofunctional monomer may include at least one selected from the group consisting of 2-(2-ethoxyethoxy)ethyl acrylate, (2-methyl-2-ethyl-1,3-dioxolan-4-yl)methyl acrylate, isobornyl acrylate, and tetrahydrofurfuryl acrylate.

8. In the radiation curing ink jet printing method of any one of 1 to 7, the radiation-curable ink composition may contain 5.0% by mass to 40.0% by mass of a pigment.

9. In the radiation curing ink jet printing method of any one of 1 to 8, the printing medium may be a polyethylene terephthalate film or a polyolefin film.

10. In the radiation curing ink jet printing method of any one of 1 to 9, the radiation-curable ink composition may be irradiated with the active radiation in an atmosphere having an oxygen concentration of 15% or less.

### BRIEF DESCRIPTION OF THE DRAWINGS

The FIGURE is a schematic view of the head and its vicinity of an ink jet printing apparatus that can be used in an embodiment of the present disclosure.

### DESCRIPTION OF EXEMPLARY EMBODIMENTS

Exemplary embodiments of the present disclosure will now be described. The following embodiments will be described by way of example. The implementation of the subject matter of the present disclosure is not limited to the following embodiments, and various modifications may be made within the scope and spirit of the disclosure. Not all the components disclosed in the following embodiments are necessarily essential for the implementation of the subject matter.

The radiation curing ink jet printing method according to the embodiments of the present disclosure is performed for forming a cured coating having a thickness of 0.5 μm to 5 μm. The method includes an ejection step of ejecting a radiation-curable ink composition onto a printing medium, and a irradiation step of irradiating the radiation-curable ink composition on the printing medium with an active radiation having an emission peak wavelength in the range of 350 nm to 420 nm from an active radiation source. The radiation-curable ink composition contains one or more monofunctional monomers and one or more multifunctional monomers in such a proportion that the ratio of the total mass of the monofunctional monomers to the total mass of the multifunctional monomers is 0.45 or more. In the irradiation step, the radiation-curable ink composition is irradiated with the active radiation in an atmosphere having an oxygen concentration lower than the atmospheric oxygen concentration.

The radiation-curable ink composition used in the radiation curing ink jet printing method and the printing method will be described in this order.

### 1. Radiation-Curable Ink Composition

The radiation-curable ink composition used herein contains one or more monofunctional monomers and one or more multifunctional monomers in such a proportion that the ratio of the total mass of the monofunctional monomers to the total mass of the multifunctional monomers is 0.45 or more.

The “radiation-curable” used herein refers to, for example, ultraviolet-curable (UV-curable) or light-curable. The radiation-curable ink composition used herein is a composition that can be cured by being irradiated with radiation and otherwise not limited. In an embodiment, the terms “radiation curing” and “radiation-curable ink composition” may be considered equivalent to, for example, “UV curing” and “UV-curable ink composition, respectively. The active radiation may be ultraviolet (UV) light, infrared (IR) light, visible light, or X rays. UV light is beneficial as the active radiation because of the prevalence thereof and the availability of the radiation source and materials that can be cured therewith.

The radiation-curable ink composition mentioned herein is an ink jet ink composition used in an ink jet printing method including an irradiation step of irradiating a radiation-curable ink composition applied onto a printing medium with an active radiation, thereby forming a cured coating. The radiation-curable ink composition may be a known ink composition.

The constituents in the radiation-curable ink composition used in an embodiment of the present disclosure will now be described.

### 1. 1. Polymerizable Compounds (Monomers)

The radiation-curable ink composition used in the embodiments disclosed herein contains one or more monofunctional monomers and one or more multifunctional monomers as polymerizable compounds in such a proportion that the ratio of the total mass of the monofunctional monomers to the total mass of the multifunctional monomers is 0.45 or more.

Polymerizable compounds, by itself or by the function of a photopolymerization initiator, are polymerized when irradiated with radiation, thus curing the ink composition on a printing medium. In an embodiment, known monofunctional, bifunctional, trifunctional, and higher multifunctional monomers and oligomers can be used as polymerizable compounds. The polymerizable compounds used in the ink composition of an embodiment may consist of a monofunctional monomer and a multifunctional monomer or may be a combination of two or more monofunctional monomers and multifunctional monomers, provided that the ratio of the total mass of the monofunctional monomers to the total mass of the multifunctional monomers is 0.45 or more.

The polymerizable compounds may include a radically polymerizable compound from the viewpoint of increasing the curability of the radiation-curable ink composition and obtaining high versatility and simplicity in use of the composition. In addition to or as an alternative to the radically polymerizable compound, the polymerizable compounds used in an embodiment may include a polymerizable compound having a vinyl ether-group (hereinafter referred to as vinyl ether-containing polymerizable compound) from the viewpoint of increasing the curability, reducing the viscosity of the composition, and increasing the solubility of the polymerization initiator that may be used. The vinyl ether-containing polymerizable compound may be a radically polymerizable vinyl ether-containing compound. For example, a vinyl ether-containing (meth)acrylate may be used as such a polymerizable compound from the same viewpoint as above.

From the viewpoint of reducing the viscosity of the ink composition, further increasing the curability of the ink composition, and having a low flash point, the vinyl ether-containing (meth)acrylate may be, but is not limited to, a compound represented by the following general formula (1):

CH₂═CR¹—COOR²—O—CH═CH—R³ (1)

wherein R¹ represents a hydrogen atom or a methyl group, R² represents a divalent organic residue having a carbon number of 2 to 20, and R³ represents a hydrogen atom or a monovalent organic residue having a carbon number of 1 to 11.

Examples of the polymerizable compound represented by general formula (1) include 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, and 2-(vinyloxyethoxyethoxyethoxyethoxy)ethyl (meth)acrylate. Such polymerizable compounds may be used individually or in combination.

Among the above-cited vinyl ether-containing (meth)acrylates, 2-(vinyloxyethoxy)ethyl (meth)acrylate, that is, either 2-(vinyloxyethoxy)ethyl acrylate or 2-(vinyloxyethoxy)ethyl methacrylate or both, is more beneficial. In some embodiments, 2-(vinyloxyethoxy)ethyl acrylate may be used. 2-(Vinyloxyethoxy)ethyl acrylate and 2-(vinyloxyethoxy)ethyl methacrylate have simple structures and a low molecular weight. By using these compounds in the ink composition, the viscosity of the ink composition can be significantly reduced. 2-(Vinyloxyethoxy)ethyl methacrylate may be 2-(2-vinyloxyethoxy)ethyl methacrylate or 2-(1-vinyloxyethoxy)ethyl methacrylate, and 2-(vinyloxyethoxy)ethyl acrylate may be 2-(2-vinyloxyethoxy)ethyl acrylate or 2-(1-vinyloxyethoxy)ethyl acrylate. 2-(Vinyloxyethoxy)ethyl acrylate is superior to 2-(vinyloxyethoxy)ethyl methacrylate in terms of curability.

The radiation-curable ink composition may further contain other monofunctional, bifunctional, trifunctional, or higher multifunctional monomers individually or in combination. Such monomers include, but are not limited to, unsaturated carboxylic acids, such as (meth)acrylic acid, itaconic acid, crotonic acid, isocrotonic acid, and maleic acid; salts of such unsaturated carboxylic acids; esters, urethanes, amides, and anhydrides of unsaturated carboxylic acids; and acrylonitrile, styrene, unsaturated polyesters, unsaturated polyethers, unsaturated polyamides, and unsaturated urethanes.

Monofunctional, bifunctional, trifunctional, and higher multifunctional oligomers include, but are not limited to, oligomers produced from the above monomers, such as linear acrylic oligomers, epoxy (meth)acrylates, oxetane (meth)acrylates, aliphatic urethane (meth)acrylates, aromatic urethane (meth)acrylates, and polyester (meth)acrylates.

The polymerizable compounds may include an N-vinyl compound as other monofunctional or multifunctional monomers. Examples of the N-vinyl compound include, but are not limited to, N-vinylformamide, N-vinylcarbazole, N-vinylacetamide, N-vinylpyrrolidone, N-vinylcaprolactam, acryloyl morpholine, and derivatives of such N-vinyl compounds.

In some embodiments, the radiation-curable ink composition may contain a monofunctional (meth)acrylate as the one or more monofunctional monomers. Such a radiation-curable ink composition can have a low viscosity, and in which the photopolymerization initiator and other constituents can be sufficiently dissolved. Accordingly, the ink composition can be consistently ejected. Examples of the monofunctional (meth)acrylate include, but are not limited to, isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, flexible lactone-modified (meth)acrylate, t-butylcyclohexyl (meth)acrylate, dicyclopentanyl (meth)acrylate, dicyclopentenyloxyethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, 2-(2-ethoxyethoxy)ethyl acrylate, (2-methyl-2-ethyl-1,3-dioxolan-4-yl)methyl acrylate, isobornyl acrylate, tetrahydrofurfuryl acrylate, phenoxyethyl acrylate, and polypropylene glycol monovinyl ether (meth)acrylate.

From the viewpoint of reducing the viscosity of the ink composition, monofunctional cyclic acrylates or monofunctional heterocyclic group-containing acrylates are used as the one or more monofunctional monomers. In particular, the ink composition containing a monofunctional heterocyclic group-containing acrylate can be not much irritant to skin as well as being not much viscus. In addition, the tackiness at the surface of the coating can be reduced by increasing the glass transition temperature Tg of the ink composition.

In some embodiments, the one or more monofunctional monomer may include at least one selected from the group consisting of phenoxyethyl acrylate, 2-(2-ethoxyethoxy)ethyl acrylate, (2-methyl-2-ethyl-1,3-dioxolan-4-yl)methyl acrylate, isobornyl acrylate, and tetrahydrofurfuryl acrylate.

The monofunctional monomer content is controlled such that the total mass of the monofunctional monomers is 0.45 or more relative to the total mass of the multifunctional monomers and is otherwise not limited. For example, the monofunctional monomer content may be 10% to 60%, 20% to 50%, or 30% to 40%, relative to the total mass of the radiation-curable ink composition. The radiation-curable ink composition containing monofunctional monomers in such a range tends to be highly curable, flexible, adhesive, and less tacky and can be consistently ejected. In addition, the polymerization initiator, if used, can be dissolved in such an ink composition.

The radiation-curable ink composition may contain a multifunctional (meth)acrylate as the one or more multifunctional monomers. Exemplary bifunctional (meth)acrylates include, but are not limited to, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol tricyclodecane di(meth)acrylate, bisphenol A ethylene oxide (EO) adduct di(meth)acrylate, bisphenol A propylene oxide (PO) adduct di(meth)acrylate, hydroxypivalic acid neopentyl glycol di(meth)acrylate, polytetramethylene glycol di(meth)acrylate, and diethylene glycol di(meth)acrylate.

Exemplary trifunctional or higher multifunctional (meth)acrylates include trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerinpropoxy tri(meth)acrylate, caprolactone-modified trimethylolpropane tri(meth)acrylate, pentaerythritolethoxy tetra(meth)acrylate, and caprolactone-modified dipentaerythritol hexa(meth)acrylate.

Dipropylene glycol di(meth)acrylate, tripropylene glycol di(meth)acrylate, diethylene glycol di(meth)acrylate, triethylene glycol di(meth)acrylate, and pentaerythritol tri(meth)acrylate are more beneficial. In some embodiments, dipropylene glycol di(meth)acrylate and pentaerythritol tri(meth)acrylate may be used.

The multifunctional monomer content is controlled such that the total mass of monofunctional monomers is 0.45 or more relative to the total mass of multifunctional monomers and is otherwise not limited. For example, the multifunctional monomer content may be 5% to 60%, 10% to 50%, or 15% to 45%, relative to the total mass of the radiation-curable ink composition. The radiation-curable ink composition containing multifunctional monomers in such a range is likely to exhibit high curability and ejection consistency and to be stably preserved. In addition, such an ink composition can form glossy coatings.

The average SP on a mass basis of the monofunctional monomers and the multifunctional monomers may be 7 to 10, for example, 8 to 9.8 or 8.5 to 9.5. From this viewpoint, lipophilic compounds may be used as a monofunctional or multifunctional monomer. The SP of lipophilic compounds is around 9 that is the SP of polyethylene terephthalate or polyolefin films, which may be used as the printing medium. Accordingly, the cured coating of the ink composition can adhere sufficiently to such a printing medium.

SP is short for solubility parameter. In the description disclosed herein, an SP refers to a Hansen solubility parameter calculated by using the equation presented below. A Hansen solubility parameter is defined by three components (parameters): dispersion term δd, polarity term δp, and hydrogen bond term δh that are derived from the Hildebrand solubility parameter, and the three parameters can be treated as coordinates for a point in a three-dimensional space. In the description disclosed herein, the SP of a material is represented as δ [(cal/cm³)^{0.5}] and calculated by the following equation:

δ [(cal/cm³)^{0.5}]=(δd²+δp²+δh²)^{0.5}

The ratio of the total mass of the monofunctional monomers to the total mass of the multifunctional monomers is 0.45 or more and is otherwise not limited. For example, such a ratio may be 0.5 or more, 0.6 or more, or 1.0 or more. The upper limit thereof may be, but is not limited to, 50.0 or less or 25.0 or less. By increasing the proportion of monofunctional monomers in the radiation-curable ink composition, a flexible cured coating can be formed. Thus, the cured coating can adhere sufficiently to the printing medium and conform to the shape of the printing medium.

### 1. 2. Coloring Material

The radiation-curable ink composition used in an embodiment may contain a coloring material. The coloring material may be at least either a pigment or a dye. In some embodiments, a pigment may be used from the viewpoint of increasing colorfastness to weather. The pigment may be an inorganic pigment or an organic pigment.

Examples of the inorganic pigment include carbon blacks (C.I. Pigment Black 7), such as furnace black, lamp black, acetylene black, and channel black, and iron oxide and titanium oxide.

Examples of the organic pigment include azo pigments, such as insoluble azo pigments, condensed azo pigments, azo lake, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates, such as basic dye chelates and acid dye chelates; dye lakes, such as basic dye lakes and acid dye lakes; and nitro pigments, nitroso pigments, carbon black, aniline black, and daylight fluorescent pigments.

Examples of black pigments include No. 2300, No. 900, MCF 88, No. 33, No. 40, No. 45, No. 52, MA7, MA8, MA100, and No. 2200B (all produced by Mitsubishi Chemical Corporation); Raven 5750, Raven 5250, Raven 5000, Raven 3500, Raven 1255, and Raven 700 (all produced by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all produced by CABOT); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all produced by Degussa).

Examples of white pigments include C.I. Pigment Whites 6, 18, and 21 and metal compounds, such as metal oxides, barium sulfate, and calcium carbonate. Exemplary metal oxides include titanium dioxide, zinc oxide, silica, alumina, and magnesium oxide.

Examples of yellow pigments include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 150, 151, 153, 154, 155, 167, 172, 180, and 185.

Examples of magenta pigments include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245 and C.I. Pigment Violets 19, 23, 32, 33, 36, 38, 43, and 50.

Examples of cyan pigments include C.I. Pigment Blues 1, 2, 3, 15, 15:1, 15:2, 15:3, 15:34, 15:4, 16, 18, 22, 25, 60, 65, and 66 and C.I. Vat Blues 4 and 60.

Pigments that can be used for colors other than magenta, cyan, and yellow include C.I. Pigment Greens 7 and 10, C.I. Pigment Browns 3, 5, 25, and 26, and C.I. Pigment Oranges 1, 2, 5, 7, 13, 14, 15, 16, 24, 34, 36, 38, 40, 43, and 63.

The above-cited pigments may be used individually or in combination.

The average particle size of the pigment, if it is used, may be 350 nm or less and may be in the range of 50 nm to 200 nm. When the pigment has such an average particle size, the radiation-curable ink composition can be reliable in terms of, for example, ejection consistency and dispersion stability, accordingly forming high-quality images. The term average particle size mentioned herein is a value measured by dynamic light scattering.

A dye may be used as the coloring material. The dye may be, but is not limited to, an acid dye, a direct dye, a reactive dye, or a basic dye. Examples of such a dye include C.I. Acid Yellows 17, 23, 42, 44, 79, and 142, C.I. Acid Reds 52, 80, 82, 249, 254, and 289, C.I. Acid Blues 9, 45, and 249, C.I. Acid Blacks 1, 2, 24, and 94, C.I. Food Blacks 1 and 2, C.I. Direct Yellows 1, 12, 24, 33, 50, 55, 58, 86, 132, 142, 144, and 173, C.I. Direct Reds 1, 4, 9, 80, 81, 225, and 227, C.I. Direct Blues 1, 2, 15, 71, 86, 87, 98, 165, 199, and 202, C.I. Direct Blacks 19, 38, 51, 71, 154, 168, 171, and 195, and C.I. Reactive Reds 14, 32, 55, 79, and 249, and C.I. Reactive Blacks 3, 4, and 35.

Such dyes may be used individually or in combination. Both a pigment and a dye may be used in combination. The coloring material content may be 0.5% to 40.0%, for example, 1.0% to 35.0% or 3.0% to 30.0%, relative to the total mass of the radiation-curable ink composition from the viewpoint of achieving high color development. In an embodiment using a white pigment as the coloring material, the white pigment content may be 10.0% to 40.0% so that the resulting ink composition can have sufficient opacity. The radiation-curable ink composition disclosed herein can provide a highly developed color in the cured coating even if the thickness of the cured coating is as small as 0.5 μm to 5 μm. Accordingly, the coloring material content can be increased to achieve high color development.

In an embodiment, the radiation-curable ink composition may be a clear ink composition. The term clear ink composition used herein refers to an ink composition not intended to color the printing medium and containing substantially no coloring material. More specifically, the clear ink composition does generally not contain a coloring material but, in a case, may contain 0.1% by mass or less or 0.05% by mass or less of a coloring material.

### 1. 3. Photopolymerization Initiator

In some embodiments, the radiation-curable ink composition may contain a photopolymerization initiator. Any photopolymerization initiator may be used provided that the polymerization initiator can produce active species, such as radicals or cations, when irradiated with an active radiation and thus initiate a polymerization reaction of the monomers. For example, a photo-radical polymerization initiator or a photo-cationic polymerization initiator may be used as the photopolymerization initiator. In some embodiments, a photo-radical polymerization initiator may be used.

In some embodiments, ultraviolet (UV) light is used as the active radiation. UV light is superior in safety, and the use of UV light reduces the cost of the light source. It is, therefore, beneficial for the photopolymerization initiator to have an absorption peak in the UV region.

Examples of the photo-radical polymerization initiator include aromatic ketones, acylphosphine oxides, aromatic onium salts, organic peroxides, thio compounds (such as thioxanthone compounds and thiophenyl group-containing compounds), hexaaryl biimidazole compounds, ketoxime ester compounds, borates, azinium compounds, metallocene compounds, active ester compounds, compounds having a carbon-halogen bond, and alkylamine compounds.

Acylphosphine oxides and thioxanthone compounds are soluble in the monomers and effective in increasing the curability of the ink composition. Accordingly, at least one selected from among acylphosphine oxides and thioxanthone compounds may be used as the photo-radical polymerization initiator. In some embodiments, an acylphosphine oxide and a thioxanthone compound may be used in combination.

More specific examples of the photo-radical polymerization initiator include acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholinopropan-1-one, bis(2,4,6-trimethylbenzoyl)phenylphosphine oxide, 2,4,6-trimethylbenzoyldiphenylphosphine oxide, 2,4-diethylthioxanthone, and bis-(2,6-dimethoxybenzoyl)-2,4,4-trimethylpentylphosphine oxide.

The photo-radical polymerization initiator may be commercially available, and examples thereof include IRGACURE 651 (2,2-dimethoxy-1,2-diphenylethane-1-one), IRGACURE 184 (1-hydroxycyclohexylphenyl ketone), DAROCUR 1173 (2-hydroxy-2-methyl-1-phenylpropane-1-one), IRGACURE 2959 (1-[4-(2-hydroxyethoxy)phenyl]-2-hydroxy-2-methyl-1-propane-1-one), IRGACURE 127 (2-hydroxy-1-{4-[4-(2-hydroxy-2-methylpropionyl)benzyl]phenyl}-2-methylpropane-1-one), IRGACURE 907 (2-methyl-1-(4-methylthiophenyl)-2-morpholinopropane-1-one), IRGACURE 369 (2-benzyl-2-dimethylamino-1-(4-morpholinophenyl)butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyldiphenylphosphine oxide), IRGACURE 819 (bis(2,4,6-trimethylbenzoyl)phenylphosphine oxide), IRGACURE 784 (bis(η5-2,4-cyclopentadiene-1-yl)-bis(2,6-difluoro-3-(1H-pyrrole-1-yl)phenyl) titanium), IRGACURE OXE 01 (1,2-octanedione, 1-[4-(phenylthio)-, 2-(O-benzoyloxime)]), IRGACURE OXE 02 (ethanone, 1-[9-ethyl-6-(2-methylbenzoyl)-9H-carbazole-3-yl]-, 1-(O-acetyloxime)), IRGACURE 754 (mixture of oxyphenyl acetic acid, 2-[2-oxo-2-phenylacetoxyethoxy]ethyl ester and 2-(2-hydroxyethoxy)ethyl ester), Lucirin TPO, LR 8893, and LR 8970 (all produced by BASF); KAYACURE DETX-S (2,4-diethylthioxanthone, produced by Nippon Kayaku); Ubecryl P36 (produced by UCB); and Speedcure TPO (diphenyl-2,4,6-trimethylbenzoylphosphine oxide) and Speedcure DETX (2,4-diethylthioxanthone) (both produced by Lambson).

Such photopolymerization initiators may be used individually or in combination.

The photopolymerization initiator may be used in a proportion of 0.05 or more, for example, 0.10 or more or 0.20 or more, relative to the total mass of the monomers in the radiation-curable ink composition. When the photopolymerization initiator is used in such a proportion, migration and an odor are reduced. In the printing method disclosed herein, the ink composition is cured in an atmosphere having a lower oxygen concentration than the atmospheric oxygen concentration, as described later herein, so as to be able to cure even though the photopolymerization initiator content is low.

More specifically, the photopolymerization initiator content may be 0.5% to 15%, for example, 1.0% to 10%, relative to the total mass of the radiation-curable ink composition. When the photopolymerization initiator content is in such a range, the radiation-curable ink composition can be rapidly cured, and the photopolymerization initiator can dissolve substantially completely in the ink composition and hardly stains the ink composition. In the printing method disclosed herein, the irradiation step is performed in an atmosphere having a lower oxygen concentration than the atmospheric oxygen concentration to suppress inhibition of the polymerization. Therefore, even though the photopolymerization initiator content is reduced, the ink composition can be sufficiently cured. Accordingly, the contents of the monomers, the coloring material, and other constituents can be increased.

The use of photopolymerizable compounds as monomers can omit the use of a photopolymerization initiator. It is however beneficial to use a polymerization initiator. Photopolymerization initiators facilitate the control of initiation of polymerization.

### 1. 4. Other Constituents

For the radiation-curable ink containing a pigment, a dispersant may be added to favorably disperse the pigment. The dispersant may be, but is not limited to, a polymer dispersant or the like that is conventionally used for preparing pigment dispersion liquids. Examples of such a polymer dispersant include polyoxyalkylene polyalkylene polyamines, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins. The polymer dispersant may contain at least one of these polymers as the main constituent. The polymer dispersant may be commercially available, and examples thereof include Discol series produced by Dai-ichi Kogyo Seiyaku, Solsperse series, such as Solsperse 36000, produced by Lubrizol Corporation, and DISPERBYK series produced by BYK Additives & Instruments.

In an embodiment, the radiation-curable ink composition may further contain a slipping agent from the viewpoint of increasing rub resistance. The slipping agent may be, but is not limited to, a silicone surfactant. The silicone surfactant may be a polyester-modified or polyether-modified silicone. In some embodiments, polyether-modified polydimethylsiloxane or polyester-modified polydimethylsiloxane may be used. Examples of such a slipping agent include BYK-347, BYK-348, BYK-UV 3500, BYK-UV 3510, BYK-UV 3530, and BYK-UV 3570 (all produced by BYK Additives & Instruments). A polyacrylate-based surfactant may also be used, and examples thereof include BYK-350, BYK-352, BYK-354, and BYK-355.

In an embodiment, the radiation-curable ink composition may further contain a polymerization inhibitor. The addition of a polymerization inhibitor to a deep ink enhances the storage stability of the ink. The polymerization inhibitor may be, but is not limited to, at least one selected from the group consisting of phenol compounds, hydroquinone compounds, and quinone compounds. More specifically, examples of such a polymerization inhibitor include hydroquinone, p-methoxyphenol, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol). A commercially available polymerization inhibitor, such as IRGASTAB UV10 or UV22 (both produced by BASF), may be used.

In an embodiment, the radiation-curable ink composition may further contain other constituents or additives. Such constituents include known additives including a polymerization promoter (sensitizing dye or the like) and a penetration enhancer. Other additives include a fixing agent, a fungicide, a preservative, an antioxidant, an ultraviolet absorbent, a chelating agent, a pH adjuster, and a thickener.

### 1. 5. Preparation of Radiation-Curable Ink Composition

The radiation-curable ink composition can be produced (prepared) by mixing the constituents and sufficiently stirring the constituents to the extent that the mixture becomes uniform. In the preparation of the ink composition, a mixture containing the photopolymerization initiator and the entire or a portion of the polymerizable compounds may be deaerated. Such treatment can reduce dissolved oxygen in the radiation-curable ink composition, and thus the ink composition can be consistently ejected and stably preserved. The mixture may further contain all or some of the other constituents of the ink composition, in addition to the photopolymerization initiator and at least a portion of the polymerizable compounds. The polymerizable compounds in the mixture can be at least a portion of the polymerizable compounds that will be contained in the radiation-curable ink composition.

### 1. 6. Physical Properties of Radiation-Curable Ink Composition

The radiation-curable ink composition used herein may have a viscosity of 5 mPa·s to 50 mPa·s, for example, 10 mPa·s to 30 mPa·s, at 20° C. The radiation-curable ink composition having a viscosity in such a range at 20° C. can be favorably applied to use in ink jet apparatuses because such an ink composition allow an appropriate amount of ejection through the nozzles to reduce the deviation or scattering of the ink composition. The viscosity of the ink composition can be measured with a viscoelasticity meter MCR-300 (manufactured by Pysica) by increasing the shear rate from 10 to 1000 at 20° C. and reading the indicated value at a shear rate of 200.

Radiation-curable ink compositions have a higher viscosity than aqueous ink compositions generally used for ink jet printing. Therefore, the viscosity of a radiation-curable ink composition of the disclosure varies considerably depending on the temperature during ejection. The changes in viscosity of the radiation-curable ink composition affect the size of the droplets of the ink composition and the ejection speed of the droplets and result in degraded image quality. Accordingly, it is desirable to keep the temperature of the ink composition as constant as possible when ejected.

In some embodiments, the surface tension of the radiation-curable ink composition may be 20 mN/m to 35 mN/m at 20° C. The ink composition having a surface tension in such a range at 20° C. is unlikely to wet the nozzles subjected to water-repellent treatment. Consequently, an appropriate amount of ejection through the nozzles can be ensured, thus reducing the deviation or scattering of the ink composition. The ink composition thus can be favorably applied to use in an ink jet apparatus. The surface tension can be determined by measuring the ink composition wetting a platinum plate at 20° C. with an automatic surface tensiometer DY-300 (manufactured by Kyowa Interface Science).

### 2. Radiation Curing Ink Jet Printing Method

The radiation-curable ink jet printing method according to an embodiment of the present disclosure will now be described.

The radiation curing ink jet printing method disclosed herein includes ejecting a radiation-curable ink composition onto a printing medium, and irradiating the radiation-curable ink composition on the printing medium with an active radiation having an emission peak wavelength in the range of 350 nm to 420 nm from an active radiation source. The radiation-curable ink composition contains at least one monofunctional monomer and at least one multifunctional monomer in such a proportion that the ratio of the total mass of the at least one monofunctional monomer to the total mass of the at least one multifunctional monomer is 0.45 or more. In the step of irradiation, the radiation-curable ink composition is irradiated in an atmosphere having an oxygen concentration lower than the atmospheric oxygen concentration. In the radiation curing ink jet printing method, a cured coating having a thickness of 0.5 μm to 5 μm is thus formed.

An ink jet printing apparatus used in the radiation curing ink jet printing method and the radiation curing ink jet printing method will be described in this order.

### 2. 1. Ink Jet Printing Apparatus

The ink jet printing apparatus used in the radiation curing ink jet printing method disclosed herein may be a line printer or a serial printer. In the following embodiment, a serial printer is used as the ink jet printing apparatus. In general, a serial printer prints, typically, by two passes or more while a head is moving reciprocally in the directions perpendicular to the direction C in which the printing medium is transported (medium transport direction). The term pass is often referred to as a main scan.

The printer used in the disclosed embodiment will now be described with reference to the FIGURE. However, the scope of the subject matter of the present disclosure is not limited to what the FIGURE suggests. For easy recognition, the dimensional proportions of the members and components in the FIGURE are varied as needed. The FIGURE is a schematic view of the head and its vicinity of an ink jet printing apparatus that can be used in an embodiment of the present disclosure.

A carriage unit 80 is a mechanism operable to move a head 85 in a direction (hereinafter referred to as a moving direction or a main scanning direction) intersecting the medium transport direction C (or the sub-scanning direction) while the head 85 is ejecting an ink composition onto a printing medium stationary at the printing position. The carriage unit 80 includes a carriage 81 and a carriage motor (not shown). The carriage 81 removably holds an ink cartridge (not shown) containing a radiation-curable ink composition. The carriage 81, which is held by a guide shaft 82 extending in a direction intersecting the medium transport direction C (describe later herein), is moved along the guide shaft 82 by the carriage motor.

The head 85 is used to eject the radiation-curable ink composition onto the printing medium and has nozzle lines N, individual ones of which include a plurality of nozzles. The head 85 is mounted on the carriage 81. When the carriage 81 moves in a moving direction M, the head 85 also moves in the same moving direction M. By intermittently ejecting the radiation-curable ink composition from the head 85 moving in a direction M, some rows of dots in the moving direction M are formed on the printing medium (not shown).

The distance from the nozzle face 86 of the head 85 to the printing side of the printing medium may be 0.5 mm to 20 mm, for example, 1 mm to 15 mm, from the viewpoint of preventing the nozzle face 86 from coming into contact with the printing medium and preventing ink droplets from deviating. In an embodiment, the distance may be as relatively large as 5 mm to 20 mm or 5 mm to 15 mm. The nozzle face 86 refers to the side opposing the printing medium of the nozzle plate of the head 85. If the distance between the nozzle face 86 and the printing side varies in the printing area of the printing medium depending on the position of the nozzle face 86 of the head 85 or the printing side, in the description disclosed herein, the largest of the varying distances is defined as the “distance” between the nozzle face 86 and the printing side of the printing medium. An example of printing at inconstant distances is the case of printing a medium having an uneven surface, as disclosed in JP-A-2000-52596. In this instance, it is beneficial to print the medium at a relatively large distance between the nozzle face 86 and the printing side. Printing under such a condition facilitates the control of printing, prevents the nozzle face 86 from coming into contact with the printing medium, and enables satisfactory image formation on a printing medium with uneven surface design.

An irradiation unit 90 is operable to irradiate the radiation-curable ink composition applied (struck) onto the printing medium with an active radiation to cure the radiation-curable ink composition. When irradiated with an active radiation emitted from the irradiation unit 90, dots formed on the printing medium are formed into a cured coating. The irradiation unit 90 includes first irradiation devices 92a and 92b on both ends in the directions M of the head 85 and a second irradiation device 93 downstream from the head 85 in the medium transport direction C (on the lower D side of the medium transport direction).

The first irradiation devices 92a and 92b are intended to irradiate the dots formed on the printing medium with an active radiation to cure the dots and are disposed on the upper U side of the medium transport direction C, or upstream from the second irradiation device 93, which is also intended to cure the dots.

More specifically, the first irradiation devices 92a and 92b function to irradiate the dots with an active radiation to preliminarily cure the dots, while the second irradiation device 93 functions to irradiate the preliminarily cured dots with an active radiation for main curing to fully cure the dots.

To “preliminarily cure” mentioned herein implies to tentatively fix (pin) an ink and, more specifically, to preliminary cure the dots before the main curing to prevent bleeding between dots and control the diameter of the dots. In general, the polymerization degree of the preliminarily cured coating of a polymerizable compound is lower than that of the fully cured coating. Also, the main curing, or to fully cure, used herein implies to cure dots on a printing medium to the extent that the printed item to have a hardness sufficient to be used.

The second irradiation device 93 is operable to irradiate the dots on the printing medium with an active radiation to the extent that the dots are substantially fully cured, thus being used for the main curing. The second irradiation device 93 is disposed downstream from the head 85 (on the lower D side) in the medium transport direction C so as to irradiate the dots formed by the head 85 with an active radiation.

The ink or dots may be cured by using any one of the first irradiation devices 92a and 92b and the second irradiation device 93 provided that the ink is fully cured by irradiation with the active radiation from at least one of those irradiation devices. In an embodiment, the irradiation step may be performed by irradiation with the active radiation from the second irradiation device 93 without using the first irradiation devices 92a and 92b. In an embodiment, at least either of the first irradiation devices 92a, 92b may be used for the main curing, irrespective of whether the second irradiation device 93 emits the active radiation. In the embodiment in which the main curing is performed by using at least either of the first irradiation devices 92a, 92b, the second irradiation device 93 may be omitted. Thus, the irradiation step may be performed by only irradiation for the main curing without performing the irradiation for the preliminary curing.

As described above, in the disclosed embodiment, the ink jet apparatus prints an image or the like by alternately repeating a main scanning motion and a sub-scanning motion. The main scanning motion is an operation for at least partially forming an image by ejecting an ink from the head 85 and curing the ink while moving the head 85 in a direction M, or a main scanning direction, and the sub-scanning motion is an operation for transporting the printing medium in the medium transport direction C, or the sub-scanning direction, intersecting the main scanning direction. Hence, the ejection step of ejecting an ink composition and the irradiation step of irradiating the ink composition with an active radiation are performed during the main scanning motion, while the printing medium is transported in the direction C by the sub-scanning motion. Thus, an image is completed on a printing medium by alternately repeating the main scanning motion and the sub-scanning motion.

Alternatively, the sub-scanning motion may be performed in such a manner that the carriage unit 80 is moved in the sub-scanning direction instead of the above-described sub-scanning motion.

### 2. 2. Radiation Curing Ink Jet Printing Method

The radiation-curable ink jet printing method disclosed herein includes an ejection step of ejecting a radiation-curable ink composition onto a printing medium, and an irradiation step of irradiating the radiation-curable ink composition on the printing medium with an active radiation having an emission peak wavelength in the range of 350 nm to 420 nm. In the irradiation step, the radiation-curable ink composition is irradiated in an atmosphere having an oxygen concentration lower than the atmospheric oxygen concentration, thus forming a cured coating having a thickness of 0.5 μm to 5 μm.

### 2. 2. 1. Ejection Step

In the ejection step of ejecting a radiation-curable ink composition, the radiation-curable ink composition is ejected from the head 85 to apply the ink composition onto a printing medium, thus forming an image.

Examples of the printing medium include, but are not limited to, plastic films made of, for example, polyvinyl chloride, polyethylene terephthalate, polypropylene, polyolefin, or polycarbonate, surface-treated films of such plastic films, glass films or plates, and coated paper sheets. In the printing method disclosed herein, a cured coating having a thickness of 0.5 μm to 5 μm is formed by using the above-described radiation-curable ink composition and irradiating the ink composition with the active radiation in an atmosphere having an oxygen concentration lower than the atmospheric oxygen concentration. The cured coating thus formed is highly flexible and can conform to the shape of the printing medium when folded, bent, or stretched. Accordingly, the radiation curing ink jet printing method is useful in printing on a polyethylene terephthalate or polyolefin film.

The amount per dot of the radiation-curable ink composition ejected in the ejection step may be 2 pL to 20 pL or 4 pL to 10 pL. The resolution of the radiation-curable ink composition may be, but is not limited to, 600 dpi×600 dpi to 1200 dpi×1200 dpi.

The radiation-curable ink composition is applied onto (printed on) the printing medium in an amount sufficient to form a cured coating having a thickness of, for example, 0.5 μm to 5 μm or 1.0 μm to 2.5 μm. The thickness of the cured coating may be adjusted by, for example, controlling the amount of ink to be ejected and the conditions for the irradiation with active radiation, such as UV light. In some embodiments, the amount of ink to be ejected is controlled.

### 2. 2. 2. Irradiation Step

The radiation curing ink jet printing method disclosed herein also includes an irradiation step of irradiating the radiation-curable ink composition on the printing medium with an active radiation having an emission peak wavelength in the range of 350 nm to 420 nm. A cured coating having a thickness of 0.5 μm to 5 μm is formed on the printing medium through this step.

The irradiation unit 90 of the above-described ink jet printing apparatus performs the irradiation. In an embodiment, a UV light emitting diode (UV-LED) emits the active radiation. The emission energy from LEDs can be easily varied by controlling the input current to the LEDs.

In the irradiation step, the active radiation is emitted at 50.0 mJ/cm² or more for one main scanning motion of the printing apparatus. In some embodiments, the irradiation energy of the active radiation for one main scanning motion may be 60.0 mJ/cm² or more, for example, 70.0 mJ/cm² or more or 65.0 mJ/cm² or more. Also, the lower limit of the irradiation intensity of the active radiation for curing may be 100 mW/cm² or more, for example, 300 mW/cm² or more or 500 mW/cm² or more. When the irradiation energy and the irradiation intensity are in such ranges, the ink composition can be sufficiently cured.

The irradiation step is performed within 1 second, beneficially 0.1 second, after the completion of the ejection step.

The irradiation step is performed in an atmosphere having an oxygen concentration lower than the atmospheric oxygen concentration. In some embodiments, the oxygen concentration for the irradiation step may be 18% or less, for example, 15% or less or 12% or less. By performing the irradiation step in an atmosphere in which the oxygen concentration is lower than the atmospheric oxygen concentration, peroxy radicals are reduced, accordingly increasing the curability of the ink composition. Also, since the peroxy radicals are reduced, polymerization inhibition is suppressed. Accordingly, the ink composition can maintain the curability even though the amount of photopolymerization initiator is reduced. Thus, thin films, which are subject to polymerization inhibition by peroxy radicals, can be sufficiently cured. In addition, the cured coating can be formed not only as thin as possible but also the coloring material content or the monomer content can be increased to prepare an ink composition capable of providing high image quality. The cured coating with an increased monomer content, particularly, an increased monofunctional monomer content, can be highly flexible and satisfactorily conform to the shape of the printing medium. Furthermore, the thin cured coating is not likely to be shrunk by curing and, accordingly, wrinkles in the printing medium can be reduced.

The irradiation step is performed, for example, in a chamber housing the above-described ink jet printing apparatus and in which oxygen is replaced with an inert gas, such as helium or nitrogen. Alternatively, the ink jet printing apparatus may be provided with a gas blower to blow the surface of the printing medium with an inert gas during irradiation to reduce the oxygen concentration at the surface of the printing medium to lower than the atmospheric oxygen concentration.

### 3. Examples

The subject matter of the present disclosure will now be further described in detail with reference to Examples and Comparative Examples. However, the implementation of the subject matter is not limited to the disclosed Examples.

### 3. 1. Preparation of Inks

The constituents of individual ink compositions presented in Tables 1 and 2 were placed into a stainless-steel mixing tank and mixed and stirred to dissolve, followed by filtration through a 5 μm membrane filter. Thus, clear inks 1 to 3 and color inks 1 to 5 were prepared. For the preparation of the inks presented in Tables 1 and 2, 50% by mass of pigments were individually dispersed in a dispersion medium to prepare respective pigment dispersion liquids in advance. The values of the constituents presented in Tables 1 and 2 are represented by percent by mass.

TABLE 1

| | | | | Exam- | Exam- | Exam- | Exam- | Exam- | Exam- | Exam- |
|---|---|---|---|---|---|---|---|---|---|---|
| | | | | ple 1 | ple 2 | ple 3 | ple 4 | ple 5 | ple 6 | ple 7 |
| | | | | Propor- | Propor- | Propor- | Propor- | Propor- | Propor- | Propor- |
| | | | Molecular | tion by | tion by | tion by | tion by | tion by | tion by | tion by |
| Constituent | Material | SP | weight | mass/g | mass/g | mass/g | mass/g | mass/g | mass/g | mass/g |
| Monofunctional | Phenoxyethyl | 9.66 | 192 | 25.00 | 25.00 | 25.00 | 25.00 | 20.00 | 35.00 | 40.00 |
| monomer A | acrylate | | | | | | | | | |
| Monofunctional | MEDOL-10 | 9.18 | 208 | | | | | | | |
| monomer B | | | | | | | | | | |
| Monofunctional | Tetrahydrofurfuryl | 9.31 | 156 | | | | | | | |
| monomer C | acrylate | | | | | | | | | |
| Monofunctional | Isobornyl acrylate | 8.37 | 208 | 9.0 | 9.0 | 9.0 | 9.0 | 10.00 | 10.00 | 40.00 |
| monomer D | | | | | | | | | | |
| Monofunctional | 2-(2-Ethoxyethoxy)ethyl | 8.90 | 188 | | | | | | | |
| monomer E | acrylate | | | | | | | | | |
| Multifunctional | 2-(2-Hydroxyethoxy)ethyl | 9.04 | 186 | 20.00 | 25.00 | 25.00 | 20.00 | 20.00 | 20.00 | |
| monomer A | acrylate | | | | | | | | | |
| Multifunctional | Dipropylene glycol | 8.92 | 242 | 20.00 | 20.45 | 19.95 | 20.00 | 5.00 | 20.00 | |
| monomer B | diacrylate | | | | | | | | | |
| Multifunctional | Dipentaerythritol | 8.93 | 578 | 7.55 | | | 7.55 | 4.30 | 8.05 | 1.55 |
| monomer C | hexaacrylate | | | | | | | | | |

| Polymerization | MEHQ | 0.20 | 0.20 | 0.20 | 0.20 | 0.20 | 0.20 | 0.20 |
|---|---|---|---|---|---|---|---|---|
| inhibitor | | | | | | | | |
| Photopolymerization | Omnirad 819 | 5.00 | 5.00 | 5.00 | 5.00 | 3.00 | 3.00 | 5.00 |
| initiator A | | | | | | | | |
| Photopolymerization | Speedcure TPO | 5.00 | 5.00 | 5.00 | 5.00 | 5.00 | 3.00 | 5.00 |
| initiator B | | | | | | | | |
| Sensitizer A | Speedcure DETX | 2.50 | 2.50 | 3.00 | 2.50 | 0.50 | 0.25 | 2.50 |
| Surfactant | BYK UV3500 | 0.50 | 0.50 | 0.50 | 0.50 | 0.50 | 0.50 | 0.50 |
| Dispersant | Solsperse36000 | 0.25 | 0.35 | 0.35 | 0.25 | 1.50 | | 0.25 |
| Cy Pigment | PB-15: 3 | 5.00 | | | | | | |
| Ma Pigment | PR-122 | | 7.00 | | | | | |
| Ye Pigment | PY-155 | | | 7.00 | | | | |
| Bk Pigment | Carbon black | | | | 5.00 | | | 5.00 |
| Wh Pigment | TiO₂ | | | | | 30.00 | | |
| Total | | 100.00 | 100.00 | 100.00 | 100.00 | 100.00 | 100.00 | 100.00 |
| Pigment content | | 5.00 | 7.00 | 7.00 | 5.00 | 30.00 | 0.00 | 5.00 |
| Monomer SP (Hansen) | | 9.12 | 9.13 | 9.13 | 9.12 | 9.12 | 9.17 | 9.01 |
| Percentage of monofunctional monomers | | 34.00 | 34.00 | 34.00 | 34.00 | 30.00 | 45.00 | 80.00 |
| Percentage of multifunctional monomers | | 47.55 | 45.45 | 44.95 | 47.55 | 29.30 | 48.05 | 1.55 |
| Monofunctional monomers/Multifunctional monomers | | 0.72 | 0.75 | 0.76 | 0.72 | 1.02 | 0.94 | 51.61 |
| Oxygen concentration | | 10% | 10% | 10% | 10% | 10% | 10% | 10% |
| Resolution | | 600 × | 600 × | 600 × | 600 × | 600 × | 600 × | 600 × |
| | | 600dpi | 600dpi | 600dpi | 600dpi | 600dpi | 600dpi | 600dpi |
| Ink volume/dot | | 4pl | 4pl | 4pl | 4pl | 4pl | 4pl | 4pl |
| Thickness at 100% dot generation | | 2.5 μm | 2.5 pm | 2.5 pm | 2.5 μm | 2.5 μm | 2.5 μm | 2.5 μm |
| Evaluation | Curability | AA | AA | AA | AA | AA | A | B |
| | Flexibility (Tensile strength) | AA | AA | AA | AA | AA | AA | AAA |
| | Wrinkles | A | A | A | A | A | A | A |
| | Image quality | AA | AA | AA | AA | AA | AA | AAA |

| | | | | Exam- | Exam- | Exam- | Exam- | Exam- | Exam- |
|---|---|---|---|---|---|---|---|---|---|
| | | | | ple 8 | ple 9 | ple 10 | ple 11 | ple 12 | ple 13 |
| | | | | Propor- | Propor- | Propor- | Propor- | Propor- | Propor- |
| | | | Molecular | tion by | tion by | tion by | tion by | tion by | tion by |
| Constituent | Material | SP | weight | mass/g | mass/g | mass/g | mass/g | mass/g | mass/g |
| Monofunctional | Phenoxyethyl | 9.66 | 192 | 17.00 | 25.00 | 25.00 | 25.00 | 25.00 | 34.00 |
| monomer A | acrylate | | | | | | | | |
| Monofunctional | MEDOL-10 | 9.18 | 208 | | | | | | |
| monomer B | | | | | | | | | |
| Monofunctional | Tetrahydrofurfuryl | 9.31 | 156 | | | | | | |
| monomer C | acrylate | | | | | | | | |
| Monofunctional | Isobornyl acrylate | 8.37 | 208 | 10.00 | 9.00 | 9.00 | 9.00 | 12.00 | |
| monomer D | | | | | | | | | |
| Monofunctional | 2-(2-Ethoxyethoxy)ethyl | 8.90 | 188 | | | | | | |
| monomer E | acrylate | | | | | | | | |
| Multifunctional | 2-(2-Hydroxyethoxy)ethyl | 9.04 | 186 | 25.00 | 20.00 | 20.00 | 20.00 | 22.00 | 20.00 |
| monomer A | acrylate | | | | | | | | |
| Multifunctional | Dipropylene glycol | 8.92 | 242 | 22.00 | 20.00 | 20.00 | 20.00 | 21.25 | 20.00 |
| monomer B | diacrylate | | | | | | | | |
| Multifunctional | Dipentaerythritol | 8.93 | 578 | 7.55 | 7.55 | 7.55 | 7.55 | 7.55 | 7.55 |
| monomer C | hexaacrylate | | | | | | | | |

| Polymerization | MEHQ | 0.20 | 0.20 | 0.20 | 0.20 | 0.20 | 0.20 |
|---|---|---|---|---|---|---|---|
| inhibitor | | | | | | | |
| Photopolymerization | Omnirad 819 | 5.00 | 5.00 | 5.00 | 5.00 | 2.50 | 5.00 |
| initiator A | | | | | | | |
| Photopolymerization | Speedcure TPO | 5.00 | 5.00 | 5.00 | 5.00 | 2.50 | 5.00 |
| initiator B | | | | | | | |
| Sensitizer A | Speedcure DETX | 2.50 | 2.50 | 2.50 | 2.50 | 1.25 | 2.50 |
| Surfactant | BYK UV3500 | 0.50 | 0.50 | 0.50 | 0.50 | 0.50 | 0.50 |
| Dispersant | Solsperse36000 | 0.25 | 0.25 | 0.25 | 0.25 | 0.25 | 0.25 |
| Cy Pigment | PB-15: 3 | | | | | | |
| Ma Pigment | PR-122 | | | | | | |
| Ye Pigment | PY-155 | | | | | | |
| Bk Pigment | Carbon black | 5.00 | 5.00 | 5.00 | 5.00 | 5.00 | 5.00 |
| Wh Pigment | TiO₂ | | | | | | |
| Total | | 100.00 | 100.00 | 100.00 | 100.00 | 100.00 | 100.00 |
| Pigment content | | 5.00 | 5.00 | 5.00 | 5.00 | 5.00 | 5.00 |
| Monomer SP (Hansen) | | 9.04 | 9.12 | 9.12 | 9.12 | 9.09 | 9.26 |
| Percentage of monofunctional monomers | | 27.00 | 34.00 | 34.00 | 34.00 | 37.00 | 34.00 |
| Percentage of multifunctional monomers | | 54.55 | 47.55 | 47.55 | 47.55 | 50.80 | 47.55 |
| Monofunctional monomers/Multifunctional monomers | | 0.49 | 0.72 | 0.72 | 0.72 | 0.73 | 0.72 |
| Oxygen concentration | | 10% | 18% | 15% | 5% | 5% | 10% |
| Resolution | | 600 × | 600 × | 600 × | 600 × | 600 × | 600 × |
| | | 600dpi | 600dpi | 600dpi | 600dpi | 600dpi | 600dpi |
| Ink volume/dot | | 4pl | 4pl | 4pl | 4pl | 4pl | 4pl |
| Thickness at 100% dot generation | | 2.5 μm | 2.5 μm | 2.5 μm | 2.5 μm | 2.5 μm | 2.5 μm |
| Evaluation | Curability | AA | B | A | AAA | A | AA |
| | Flexibility (Tensile strength) | A | AA | AA | AA | AA | AA |
| | Wrinkles | A | A | A | A | A | A |
| | Image quality | AA | AA | AA | AA | AA | A |

TABLE 2

| | | | | Exam- | Exam- | Exam- | Exam- | Exam- | Exam- | Exam- | Exam- |
|---|---|---|---|---|---|---|---|---|---|---|---|
| | | | | ple 14 | ple 15 | ple 16 | ple 17 | ple 18 | ple 19 | ple 20 | ple 21 |
| | | | | Propor- | Propor- | Propor- | Propor- | Propor- | Propor- | Propor- | Propor- |
| | | | Molecular | tion by | tion by | tion by | tion by | tion by | tion by | tion by | tion by |
| Constituent | Material | SP | weight | mass/g | mass/g | mass/g | mass/g | mass/g | mass/g | mass/g | mass/g |
| Monofunctional | Phenoxyethyl | 9.66 | 192 | 10.00 | 10.00 | 10.00 | 10.00 | 25.00 | 25.00 | 25.00 | 25.00 |
| monomer A | acrylate | | | | | | | | | | |
| Monofunctional | MEDOL-10 | 9.18 | 208 | 24.00 | | | | | | | |
| monomer B | | | | | | | | | | | |
| Monofunctional | Tetrahydrofurfuryl | 9.31 | 156 | | 24.00 | | | | | | |
| monomer C | acrylate | | | | | | | | | | |
| Monofunctional | Isobornyl acrylate | 8.37 | 208 | | | 24.00 | | 7.00 | 9.00 | 9.00 | 9.00 |
| monomer D | | | | | | | | | | | |
| Monofunctional | 2-(2-Ethoxyethoxy)ethyl | 8.90 | 188 | | | | 24.00 | | | | |
| monomer E | acrylate | | | | | | | | | | |
| Multifunctional | 2-(2-Hydroxyethoxy)ethyl | 9.04 | 186 | 20.00 | 20.00 | 20.00 | 20.00 | 20.00 | 20.00 | 20.00 | 20.00 |
| monomer A | acrylate | | | | | | | | | | |
| Multifunctional | Dipropylene glycol | 8.92 | 242 | 20.00 | 20.00 | 20.00 | 20.00 | 20.00 | 20.00 | 20.00 | 20.00 |
| monomer B | diacrylate | | | | | | | | | | |
| Multifunctional | Dipentaerythritol | 8.93 | 578 | 7.55 | 7.55 | 7.55 | 7.55 | 7.45 | 7.55 | 7.55 | 7.55 |
| monomer C | hexaacrylate | | | | | | | | | | |

| Polymerization | MEHQ | 0.20 | 0.20 | 0.20 | 0.20 | 0.20 | 0.20 | 0.20 | 0.20 |
|---|---|---|---|---|---|---|---|---|---|
| inhibitor | | | | | | | | | |
| Photopolymerization | Omnirad 819 | 5.00 | 5.00 | 5.00 | 5.00 | 5.00 | 5.00 | 5.00 | 5.00 |
| initiator A | | | | | | | | | |
| Photopolymerization | Speedcure TPO | 5.00 | 5.00 | 5.00 | 5.00 | 5.00 | 5.00 | 5.00 | 5.00 |
| initiator B | | | | | | | | | |
| Sensitizer A | Speedcure DETX | 2.50 | 2.50 | 2.50 | 2.50 | 2.50 | 2.50 | 2.50 | 2.50 |
| Surfactant | BYK UV3500 | 0.50 | 0.50 | 0.50 | 0.50 | 0.50 | 0.50 | 0.50 | 0.50 |
| Dispersant | Solsperse36000 | 0.25 | 0.25 | 0.25 | 0.25 | 0.35 | 0.13 | 0.25 | 0.25 |
| Cy Pigment | PB-15: 3 | | | | | | | | |
| Ma Pigment | PR-122 | | | | | | | | |
| Ye Pigment | PY-155 | | | | | | | | |
| Bk Pigment | Carbon black | 5.00 | 5.00 | 5.00 | 5.00 | 7.00 | 2.50 | 5.00 | 5.00 |
| Wh Pigment | TiO₂ | | | | | | | | |
| Total | | 100.00 | 100.00 | 100.00 | 100.00 | 100.00 | 97.38 | 100.00 | 100.00 |
| Pigment content | | 5.00 | 5.00 | 5.00 | 5.00 | 7.00 | 2.50 | 5.00 | 5.00 |
| Monomer SP (Hansen) | | 8.24 | 7.97 | 8.12 | 8.16 | 8.17 | 8.17 | 8.17 | 8.17 |
| Percentage of monofunctional monomers | | 34.00 | 34.00 | 34.00 | 34.00 | 32.00 | 34.00 | 34.00 | 34.00 |
| Percentage of multifunctional monomers | | 47.55 | 47.55 | 47.55 | 47.55 | 47.45 | 47.55 | 47.55 | 47.55 |
| Monofunctional monomers/Multifunctional monomers | | 0.72 | 0.72 | 0.72 | 0.72 | 0.67 | 0.72 | 0.72 | 0.72 |
| Initiator/Monomers | | 0.15 | 0.15 | 0.15 | 0.15 | 0.16 | 0.15 | 0.15 | 0.15 |
| Oxygen concentration | | 10% | 10% | 10% | 10% | 10% | 10% | 10% | 10% |
| Resolution | | 600 × | 600 × | 600 × | 600 × | 600 × | 600 × | 600 × | 1200 × |
| | | 600dpi | 600dpi | 600dpi | 600dpi | 600dpi | 600dpi | 1200dpi | 1200dpi |
| Ink volume/dot | | 4pl | 4pl | 4pl | 4pl | 2pl | 10pl | 2pl | 1pl |
| Thickness at 100% dot generation | | 2.5 μm | 2.5 μm | 2.5 μm | 2.5 μm | 1 μm | 5 μm | 2.5 μm | 2.5 μm |
| Evaluation | Curability | AA | AA | AA | AA | A | AA | AA | AA |
| | Flexibility (Tensile strength) | AA | AA | AA | AA | AA | AA | AA | AA |
| | Wrinkles | A | A | A | A | A | A | A | A |
| | Image quality | AAA | AAA | AAA | AAA | A | AA | AA | AA |

| | | | | Compar- | Compar- | Compar- | Compar- | Compar- |
|---|---|---|---|---|---|---|---|---|
| | | | | ative | ative | ative | ative | ative |
| | | | | Example 1 | Example 2 | Example 3 | Example 4 | Example 5 |
| | | | | Propor- | Propor- | Propor- | Propor- | Propor- |
| | | | Molecular | tion by | tion by | tion by | tion by | tion by |
| Constituent | Material | SP | weight | mass/g | mass/g | mass/g | mass/g | mass/g |
| Monofunctional | Phenoxyethyl | 9.66 | 192 | 25.00 | 22.00 | 25.00 | 25.00 | 25.00 |
| monomer A | acrylate | | | | | | | |
| Monofunctional | MEDOL-10 | 9.18 | 208 | | | | | |
| monomer B | | | | | | | | |
| Monofunctional | Tetrahydrofurfuryl | 9.31 | 156 | | | | | |
| monomer C | acrylate | | | | | | | |
| Monofunctional | Isobornyl acrylate | 8.37 | 208 | 9.00 | | 13.00 | 10.60 | 9.00 |
| monomer D | | | | | | | | |
| Monofunctional | 2-(2-Ethoxyethoxy)ethyl | 8.90 | 188 | | | | | |
| monomer E | acrylate | | | | | | | |
| Multifunctional | 2-(2-Hydroxyethoxy)ethyl | 9.04 | 186 | 20.00 | 26.00 | 20.00 | 20.00 | 20.00 |
| monomer A | acrylate | | | | | | | |
| Multifunctional | Dipropylene glycol | 8.92 | 242 | 20.00 | 26.00 | 20.00 | 20.00 | 20.00 |
| monomer B | diacrylate | | | | | | | |
| Multifunctional | Dipentaerythritol | 8.93 | 578 | 7.55 | 7.55 | 7.49 | 7.52 | 7.55 |
| monomer C | hexaacrylate | | | | | | | |

| Polymerization | MEHQ | 0.20 | 0.20 | 0.20 | 0.20 | 0.20 |
|---|---|---|---|---|---|---|
| inhibitor | | | | | | |
| Photopolymerization | Omnirad 819 | 5.00 | 5.00 | 5.00 | 5.00 | 5.00 |
| initiator A | | | | | | |
| Photopolymerization | Speedcure TPO | 5.00 | 5.00 | 5.00 | 5.00 | 5.00 |
| initiator B | | | | | | |
| Sensitizer A | Speedcure DETX | 2.50 | 2.50 | 2.50 | 2.50 | 2.50 |
| Surfactant | BYK UV3500 | 0.50 | 0.50 | 0.50 | 0.50 | 0.50 |
| Dispersant | Solsperse36000 | 0.25 | 0.25 | 0.06 | 0.18 | 0.25 |
| Cy Pigment | PB-15: 3 | | | | | |
| Ma Pigment | PR-122 | | | | | |
| Ye Pigment | PY-155 | | | | | |
| Bk Pigment | Carbon black | 5.00 | 5.00 | 1.25 | 3.50 | 5.00 |
| Wh Pigment | TiO₂ | | | | | |
| Total | | 100.00 | 100.00 | 100.00 | 100.00 | 100.00 |
| Pigment content | | 5.00 | 5.00 | 1.25 | 3.50 | 5.00 |
| Monomer SP (Hansen) | | 8.17 | 8.17 | 8.21 | 8.19 | 8.17 |
| Percentage of monofunctional monomers | | 34.00 | 22.00 | 38.00 | 35.60 | 34.00 |
| Percentage of multifunctional monomers | | 47.55 | 59.55 | 47.49 | 47.52 | 47.55 |
| Monofunctional monomers/Multifunctional monomers | | 0.72 | 0.37 | 0.80 | 0.75 | 0.72 |
| Initiator/Monomers | | 0.15 | 0.15 | 0.15 | 0.15 | 0.15 |
| Oxygen concentration | | 21% | 10% | 10% | 10% | 10% |
| Resolution | | 600 × | 600 × | 600 × | 600 × | 600 × |
| | | 600dpi | 600dpi | 600dpi | 600dpi | 600dpi |
| Ink volume/dot | | 4pl | 4pl | 20pl | 14pl | 0.5pl |
| Thickness at 100% dot generation | | 2.5 μm | 2.5 μm | 10 μm | 7 μm | 0.2 μm |
| Evaluation | Curability | C | AA | AA | A | C |
| | Flexibility (Tensile strength) | AA | B | AA | A | AA |
| | Wrinkles | A | A | B | B | A |
| | Image quality | AA | A | AA | AA | B |

Abbreviations used in the Tables are as follows:

MEDOL-10: product name of (2-methyl-2-ethyl-1,3-dioxolan-4-yl)methyl acrylate produced by Osaka Organic Chemical Industry

MEHQ: p-methoxyphenol (product name), hydroquinone monomethyl ether produced by Kanto Chemical

BYK-UV 3500: product name of polyether-modified acryloyl-group containing polydimethylsiloxane produced by BYK Additives & Instruments)

Solsperse 36000: product of Lubrizol

### Pigments

Carbon Black: black pigment

PB15:3: C.I. Pigment Blue 15:3, cyan pigment

PR122: C.I. Pigment Red 122, magenta pigment

PY155: C.I. Pigment Yellow 155, yellow pigment

Titanium oxide: white pigment

### 3. 2. Printing Test

A serial printer as illustrated in the FIGURE was used. More specifically, an ink jet printer PX-G5000 (manufactured by Seiko Epson) was provided with a light source (UV-LED, described later herein) downstream from the carriage and the platen in the sub-scanning direction. The head was provided with a heater capable of heating the ink for temperature control of the ink to be ejected. The head was charged with any of the inks. The head scanned the printing medium while ejecting the ink to print on the medium. The nozzle density of the nozzle lines used for printing was 300 dpi in the sub-scanning direction.

The ink on the printing medium applied during the main scanning motion was irradiated every pass (every main scanning motion) with a radiation having a peak wavelength of 395 nm from an LED mounted on a side of the carriage, thus being cured preliminarily. In this instance, a Firefly LED (irradiation peak intensity: 1,000 mW/cm²) was used as the LED on the side of the carriage. The irradiation energy during individual one of passes was 100 mJ/cm².

The printing medium was subsequently transported (sub-scanned) in the sub-scanning direction intersecting the main scanning directions and then subjected to the next main scanning motion. Thus, main scanning motion and sub-scanning motion were alternately repeated.

After the completion of printing (after the last main scanning motion), the printing medium was transported downstream from the platen in the sub-scanning direction, and the ink on the printing medium was further irradiated with radiation from another light source (but the same type as the light source on the side of the carriage) disposed across the width of the printing medium, thus being fully cured. The irradiation energy for curing was 400 mJ/cm².

The number of passes (number of main scanning motions) for printing was 4 (=2 passes (main scanning directions)×2 passes (sub-scanning direction)). More specifically, overlap printing that forms dots every two pixels of a single raster line by a single pass was performed in such a manner that any one of raster lines of dots formed by main scanning motions lay between two raster lines of dots formed by another main scanning motion. The distance between the nozzle face and the printing side of the printing medium was set at 1 mm. A pattern was formed at a dot generation rate of 100% at a resolution (sub-scanning direction×main scanning direction) of 600 dpi×600 dpi.

The serial printer was placed in a chamber in which the oxygen concentration was reduced to the level presented in Tables 1 and 2 by introducing flowing N₂ gas. The oxygen concentration was measured in the vicinity of the irradiation unit with an oxygen meter manufactured by Ichinen Jikco. The thickness was adjusted so that the ink ejection rate came to the ink volume/dot presented in Tables 1 and 2. The printing medium was a biaxially oriented polypropylene (OPP) film FOA (thickness: 20 μm) manufactured by Futamura Chemical.

### 3. 3. Evaluation

### 3. 3. 1. Curability

In Example 1, a solid pattern was printed on a PET film with the ink composition at a resolution of 600 dpi×600 dpi by using the printer (PX-G5000 manufactured by Seiko Epson). The solid pattern is a pattern in which all the pixels, which are the minimum printing units defined by resolution, are filled with ink, that is, a pattern formed at a dot generation rate of 100%. The oxygen concentration was reduced to 10% in a manner as described in “3. 2. Printing Test”, and the volume per dot of ink was set to 4 pL. Under such conditions, the solid pattern was printed so that the thickness could be 2.5 μm after curing.

Then, the PET film on which the solid pattern had been printed was irradiated with UV light having a center wavelength of 395 nm at 1000 mW/cm² by using a UV irradiation unit with an LED (for in-house test). Cumulative irradiation energy (mJ/cm²) was calculated as a product of the irradiation intensity (mW/cm²) at a surface irradiated by the light source and the time (s) of continuing irradiation. Other conditions were as described in “3. 2. Printing Test”.

Irradiation intensity was measured with a UV intensity meter UM-10 and a light receiver UM-400 (both produced by Konica Minolta Sensing). Whether the cured coating was free from tackiness was determined by whether or not the ink adhered to a cotton swab or whether or not the cured coating on the printing medium was scratched. Johnson swabs manufactured by Johnson & Johnson were used as the cotton swab. For the scratch test, the cured coating was reciprocally rubbed ten times at a load of 100 g. The thickness of the cured coating to be tested was 2.5 μm. Samples rated as B or better were determined to be good in terms of curability. The solid patterns of Examples 2 to 21 and Comparative Examples 1 to 5 were subjected to the same test and evaluated in the same manner, except that the ink composition and the conditions accorded to those presented in Tables 1 and 2.

### Criteria

AAA: The cumulative irradiation energy when the solid pattern reached a tackiness free condition was less than 150 mJ/cm².

AA: The cumulative irradiation energy when the solid pattern reached a tackiness free condition was 150 mJ/cm² to less than 200 mJ/cm².

A: The cumulative irradiation energy when the solid pattern reached a tackiness free condition was 200 mJ/cm² to less than 300 mJ/cm².

B: The cumulative irradiation energy when the solid pattern reached a tackiness free condition was 300 mJ/cm² to less than 400 mJ/cm².

C: The cumulative irradiation energy when the solid pattern reached a tackiness free condition was 400 mJ/cm² or more.

### 3. 3. 2. Flexibility

The film printed in “3. 2.” was cut to a specific size with a length L₀. The cut film was subjected to a tensile test at a tensile speed of 100 mm/min with a tensile tester manufactured by A & D, and visually checked for cracks in the cured coating or peeling of the cured coating. The cut film was drawn until the cured coating was cracked or peeled, and the length L₁ of the film at this time was calculated based on the period from the beginning of the tensile test to the point when the cured coating cracked or peeled. The elongation (%) at cracking or peeling of the cured coating on the PVC film was calculated from the following equation (2) for evaluating the flexibility of the cured coating. Samples rated as A or better were determined to be good in terms of flexibility.

Elongation (%) at cracking or peeling={(L₁−L₀)/L₀}×100 (2)

### Criteria

AAA: Elongation was 200% or more.

AA: Elongation was 150% to less than 200%.

A: Elongation was 120% to less than 150%.

B: Elongation was less than 120%.

### 3. 3. 3. Wrinkles

The pattern was printed to a presented thickness on the film according to the description in “3. 2.”, and wrinkles in the film were visually observed. Samples rated as A were determined to be good.

### Criteria

A: There were no wrinkles in the film.
B: Wrinkles were seen in the film.

### 3. 3. 4. Image Quality

A 20 cm×20 cm solid pattern was printed by applying ink to each pixel at a rate of volume per dot presented in the Tables to form dots and curing the dots. A pixel is a minimum printing unit defined by printing resolution. How much the solid pattern formed at dot generation rate of 100% was filled with the ink was visually observed at a distance of 30 cm from the printing medium. Samples rated as A were determined to be good in terms of image quality.

### Criteria

AAA: 85% or more

AA: 70% to less than 85%

A: 50% to less than 70%

B: 50% or less

### 3. 4. Evaluation Results

The inks of Examples 1 to 6 were superior in curability irrespective of the type and the presence or absence of pigment. The results of Examples 7 and 8 suggest that a higher monomer content results in lower curability but higher flexibility and image quality. The results of Examples 9 to 11 suggest that a lower oxygen concentration results in higher curability. The results of Examples 11 and 12 show that when the oxygen concentration was 5%, the ink was sufficiently cured even though the photopolymerization initiator content was reduced. The results of Examples 4 and 13 to 17 show that the inks containing two monofunctional monomers provided higher image quality. The inks of Examples 4, 18, and 19 were able to form a cured coating having a thickness of 1 μm to 5 μm. The results of Examples 4, 20, and 21 show that the cured coating of the ink was good in all the evaluation items despite being printed at varying resolutions.

In contrast, the pattern of Comparative Example 1 formed in an atmosphere having a higher oxygen concentration exhibited lower curability than the pattern of Example 4. In the Comparative Example 2, in which the mass ratio of the monofunctional monomers to the multifunctional monomers was lower, the flexibility of the cured coating was lower than that in Example 4. In the thick patterns of Comparative Examples 3 and 4, wrinkles were formed to a larger extent than in Example 4. The thin pattern of Comparative Example 5 was inferior to the pattern of Example 4 in terms of curability and image quality.

The implementation of the subject matter disclosed herein is not limited to the above-described embodiments, and various modifications may be made. For example, the subject matter may be implemented in substantially the same manner as any of the disclosed embodiments (for example, in terms of function, method, and results, or in terms of purpose and effect). Some elements used in the disclosed embodiments but not essential may be replaced. Implementations capable of producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

What is claimed is:

1. A radiation curing ink jet printing method for forming a cured coating having a thickness of 0.5 μm to 5 μm, the method comprising:
an ejection step of ejecting a radiation-curable ink composition onto a printing medium, and
an irradiation step of irradiating the radiation-curable ink composition on the printing medium with an active radiation having an emission peak wavelength in the range of 350 nm to 420 nm from an active radiation source in an atmosphere having an oxygen concentration lower than the oxygen concentration in an atmospheric environment,
wherein
the radiation-curable ink composition contains at least one monofunctional monomer and at least one multifunctional monomer in such a proportion that the ratio of the total mass of the at least one monofunctional monomer to the total mass of the at least one multifunctional monomer is 0.45 or more.

2. The radiation curing ink jet printing method according to claim 1, wherein
the radiation-curable ink composition further contains a photopolymerization initiator in a proportion of 0.20 or more relative to the total mass of all the monomers.

3. The radiation curing ink jet printing method according to claim 1, wherein
the radiation-curable ink composition further contains a white pigment.

4. The radiation curing ink jet printing method according to claim 1, wherein
the average solubility parameter on a mass basis of the at least one monofunctional monomer and the at least one multifunctional monomer is 7 to 10.

5. The radiation curable ink jet printing method according to claim 1, wherein
the at least one monofunctional monomer includes a monofunctional cyclic acrylate.

6. The radiation curing ink jet printing method according to claim 1, wherein
the at least one monofunctional monomer includes a monofunctional heterocyclic acrylate.

7. The radiation curing ink jet printing method according to claim 1, wherein
the at least one monofunctional monomer includes at least one selected from the group consisting of 2-(2-ethoxyethoxy)ethyl acrylate, (2-methyl-2-ethyl-1,3-dioxolan-4-yl)methyl acrylate, isobornyl acrylate, and tetrahydrofurfuryl acrylate.

8. The radiation curing ink jet printing method according to claim 1, wherein
the radiation-curable ink composition contains 5.0% by mass to 40.0% by mass of a pigment.

9. The radiation curing ink jet printing method according to claim 1, wherein
the printing medium is a polyethylene terephthalate film or a polyolefin film.

10. The radiation curing ink jet printing method according to claim 1, wherein
the radiation-curable ink composition is irradiated with the active radiation in an atmosphere having an oxygen concentration of 15% or less.
